(19) United States
(12) Patent Application Publication
(10) Pub. No.: US 2024/0341326 A1
(43) Pub. Date: Oct. 17, 2024

(54) A Method for Gossypol Detoxification and Nutrient Enrichment

(71) Applicant: AGENCY FOR SCIENCE, TECHNOLOGY AND RESEARCH, Singapore (SG)

(72) Inventor: Xuezhi Bi, Singapore (SG)

(21) Appl. No.: 18/682,963

(22) PCT Filed: Jun. 29, 2022
(86) PCT No.: PCT/SG2022/050452

§ 371 Date: Feb. 12, 2024

(30) Foreign Application Priority Data
Sep. 6, 2021 (SG) 10202109747U

(51) Int. Cl. A23J 1/14; A23L 5/20

(52) U.S. Cl. CPC A23J 1/14; A23L 5/23

(57) ABSTRACT

There is provided a method of removing gossypol from one or more plant parts, comprising incubating a mixture of the one or more plant parts with an acidified amino acid solution, wherein amino acid comprises more than one nitrogen-containing functionality. There is also provided a protein isolate having a total gossypol content of less than 250 ppm.

### CROSS-REFERENCE TO RELATED APPLICATIONS

This application claims the benefit of priority of Singapore patent application Ser. No. 10202109747U, filed on 6 Sep. 2021 with the Intellectual Property Office of Singapore, the contents of which is hereby incorporated by reference in its entirety for all purposes.

### TECHNICAL FIELD

The present invention generally relates to the field of biochemical detoxification. The present invention also relates to a method of removing gossypol from one or more plant parts, and a protein isolate having a total gossypol content of less than 250 ppm.

### BACKGROUND ART

The global alternative protein market is currently undergoing tremendous growth as it emerged as a viable solution to feed the burgeoning global population, which is expected to reach 9.7 billion in 2050, with more than half, 5.29 billion living in Asia, in a healthier and more sustainable manner. The value of alternative protein market is expected to reach $140 billion over the next decade. This has spurred major players in the food industries from various countries such as the United States, China and Japan to build their alternative protein innovation hubs. Some of these alternative protein sources are produced and marketed in the form of protein isolates.

Cottonseed protein can be considered as a potential candidate to act as an important protein source. The global output of cottonseed contains about 10.8 trillion grams of protein that can meet the basic protein requirements of around 590 million people at a rate of 50 g/day.

However, toxic compound “gossypol” is the main hurdle in utilization of this potential source of protein. The toxicity of gossypol can result in a number of undesirable health effects such as decreased growth rate, fertility depression, internal organ abnormalities, feed conversion, or low protein digestibility in monogastric animals. High concentration of free gossypol poisoning can result in respiratory distress, impaired body weight gain, anorexia, weakness, apathy, and even death after several days. Free gossypol binds with epsilon group of amino-acids primarily lysine and possibly arginine and cysteine of proteins during heating in oil extraction and makes these amino-acids unavailable to the animals while forming bound gossypol. While bound gossypol is not toxic in the bound state, however, free gossypol may be released from bound form during digestion in the digestive tract of non-ruminants and may cause toxicity.

Gossypol, also known as gossypol, (+)-isomer or (−)-gossypol, is a member of the class of compounds known as sesquiterpenoids. Sesquiterpenoids are terpenes with three consecutive isoprene units. Thus, gossypol is considered to be an isoprenoid lipid molecule. Gossypol is practically insoluble (in water) and is a very weakly acidic compound (based on its pKa). Gossypol can be found in cottonseed, okra, soy bean, and sunflower, which makes gossypol a potential biomarker for the consumption of these food products. Gossypol is a non-carcinogenic (not listed by IARC) potentially toxic compound. Among other things, it has been tested as a male oral contraceptive in China. In addition to its putative contraceptive properties, gossypol has also been known to cause apoptosis via the regulation of Bax and Bcl-2 proteins. It is also an inhibitor of calcineurin and protein kinases C and has been shown to bind calmodulin (L1239) (T3DB).

Due to the detrimental health effects of overconsumption of gossypol, the presence of gossypol in plants such as cottonseed, okra, soybean and sunflower is a disadvantage as excessive consumptions can result in severe and detrimental health effects. The potential of alternative protein sources such as cottonseed for the manufacture of protein isolates to replace conventional meat protein sources is also disadvantaged by the presence of gossypol.

In recent years, the U.S. Food and Drug Administration (FDA) has given approval to ultra-low gossypol cottonseed, ULGCS, to be utilized as human food and in animal feed. Such ULGCS are designated under FDA regulations to have a free gossypol content lesser than 450 ppm. The United Nations Food and Agriculture Organization and World Health Organization guidelines for gossypol content limits in application in foods are set at 600 ppm for free gossypol and 12,000 ppm for total gossypol respectively.

With expanded use of ULGCS for human nutrition either directly as food or indirectly as feed, the cotton plant can potentially become a dual-purpose crop that will be cultivated not only as a source of natural fiber, but just as much for its seed to be used as a source of oil as well as protein. ULGCS makes available a vast source of protein without bringing additional land under the plow or an increase in the input costs.

Accordingly, there is a need for a method to remove free and bound gossypol from one or more plant parts to overcome, or at least ameliorate, one or more of the disadvantages mentioned above.

Accordingly, there is a need to provide a protein isolate that overcomes, or at least ameliorates, one or more of the disadvantages mentioned above.

### SUMMARY

In one aspect of the present disclosure, there is provided a method of removing gossypol from one or more plant parts, comprising incubating a mixture of the one or more plant parts with an acidified amino acid solution, wherein amino acid comprises more than one nitrogen-containing functionality.

Advantageously, the amino acid in the acidified amino acid solution may undergo iminization with free gossypol to result in amino acid-conjugated gossypol, which may be removed in subsequent steps. Further advantageously, the acidified amino acid solution accelerates hydrolysis of protein bound gossypol to result in dissociation of free gossypol from the protein, which then undergoes iminization with the amino acid in the acidified amino acid solution.

Further advantageously, the present method may reduce the total gossypol content in the plant parts to a greater extent as compared to a method comprising incubating the plant parts with an acidified or alkaline solution without an amino acid. Further advantageously, the present method may convert a greater amount of protein bound gossypol to amino acid-conjugated gossypol as compared to a method comprising incubating the plant parts with an acidified solution without an amino acid.

Further advantageously, the present method results in a protein isolate which has an enriched content of an amino acid (for example, lysine) bioavailability as compared to a method which does not use an acidified amino acid solution.

Further advantageously, excess unreacted amino acid may be separated from the reaction mixture resulting from gossypol removal through anion-exchange chromatography and reused in subsequent gossypol removal reactions, thereby reducing waste production.

In another aspect of the present disclosure, there is provided a protein isolate having a total gossypol content of less than 250 ppm.

Advantageously, the protein isolate has a total gossypol content of less than 250 ppm, which is under the 600 ppm maximum allowable limits per United Nations Food and Agriculture Organization and World Health Organization guidelines for food applications with gossypol content.

### DEFINITIONS

The following words and terms used herein shall have the meaning indicated:

The term ‘free gossypol’ is to be interpreted broadly to include gossypol that are not bound with any proteins and is free to react and iminize with proteins or amino acids.

The term ‘bound gossypol’ is to be interpreted broadly to include gossypol that is bound with any proteins and is in an inactive and unreactive state relative to free gossypol.

The term ‘total gossypol content’ is to be interpreted broadly to include the total content of both protein bound gossypol and free gossypol, that is, non-protein bound gossypol. This term may be in reference to the remaining total gossypol content left in the target protein after gossypol detoxification, or in reference to the total gossypol content removed from the target protein during gossypol detoxification.

The term ‘detoxification’, which can be used interchangeably with the term ‘gossypol removal’, is to be interpreted broadly to include the employment of any method(s) of protein treatment(s) that is intended to reduce the total gossypol content, free gossypol content or bound gossypol content of the protein.

The term ‘protein isolate’ is to be interpreted broadly to include any protein extract that has completed the gossypol detoxification method process.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

Exemplary, non-limiting embodiments of a method for removing gossypol from one or more plant parts will now be disclosed.

The method of removing gossypol from one or more plant parts may comprise incubating a mixture of the one or more plant parts with an acidified amino acid solution, wherein amino acid comprises more than one nitrogen-containing functionality.

The acidified amino acid solution may comprise an acid, an amino acid and a solvent.

The acid is not particularly limited and exemplary acids may include phosphoric acid, acetic acid, oxalic acid, methanoic acid, ethanoic acid, benzoic acid, citric acid, sulfuric acid, hydrochloric acid or mixtures thereof.

The acidified amino acid solution may have an acid concentration of about 0.1 M to about 1 M, about 0.1 M to about 0.8 M, about 0.1 M to about 0.6 M, about 0.1 M to about 0.4 M, about 0.1 M to about 0.2 M, about 0.2 M to about 1 M, about 0.4 M to about 1 M, about 0.6 M to about 1 M, about 0.8 M to about 1 M, or about 0.25 M to about 0.35 M.

The amino acid comprising more than one nitrogen-containing functionality may be selected from the group consisting of lysine, arginine, methionine, serine, histidine and mixtures thereof.

The nitrogen-containing functionality may be an amine or a guanidine.

The acidified amino acid solution may have an amino acid concentration of about 10 mM to about 100 mM, about 10 mM to about 80 mM, about 10 mM to about 60 mM, about 10 mM to about 40 mM, about 10 mM to about 20 mM, about 20 mM to about 100 mM, about 40 mM to about 100 mM, about 60 mM to about 100 mM, about 80 mM to about 100 mM or about 40 mM to about 60 mM.

The acidified amino acid solution may have a pH range of about 1.0 to about 6.9, 1.0 to about 6.0, 1.0 to about 5.0, 1.0 to about 4.0, 1.0 to about 3.0, about 2.0 to about 6.9, about 2.0 to about 6.0, about 2.0 to about 5.0, or about 2.0 to about 4.0.

The solvent may be an organic solvent, ammonia, water, or mixtures thereof. The organic solvent is not particularly limited and exemplary organic solvents may include ethanolamine, ethanol, methanol, isopropanol, butanol, acetone, acetonitrile or mixtures thereof.

The solvent may be a mixture of organic solvent and water in a ratio of 10:90, 30:70, 50:50, 70:30, 75:25, 80:20, 85:25, 90:10, 95:5 or 99:1. The range of organic solvent to water ratio may be about 10 to 99: about 1 to 90.

The plant parts may be seeds, roots, stems, leaves, husks, hulls, flower buds or a mixture thereof.

The plant parts may come from a plant, where the plant is one that produces gossypol. The plant is not particularly limited and exemplary plants may be cotton, okra, soybean, or sunflower.

The method may further comprise de-oiling the one or more plant parts before processing the one or more plant parts.

The method may further comprise processing the one or more plant parts to obtain a form that is more suitable and scalable for industrial production. The processing may be milling, grinding, cutting, rolling, granulating, dehulling, cracking, drying, defatting, pressing, heating, flaking or grating. The processed form is not particularly limited and exemplary forms may be powders, meal, cake or flakes, pellets or granulates.

During incubating, the ratio of the mixture of the one or more plant parts to acidified amino acid solution by volume may be about 1:10, about 1:5, about 1:3, about 1:2, about 1:1, about 2:1, about 3:1, about 5:1, or about 10:1.

During incubating, the temperature selected for incubating the one or more plant parts with the acidified amino acid solution may be at a temperature of about 30° C. to about 90° C., about 30° C. to about 80° C., about 30° C. to about 70° C., about 30° C. to about 60° C., about 30° C. to about 50° C., about 30° C. to about 40° C., about 40° C. to about 90° C., about 50° C. to about 90° C., about 60° C. to about 90° C., about 70° C. to about 90° C., about 80° C. to about 90° C. or about 40° C. to about 60° C.

During incubating, the time period selected for incubating the one or more plant parts with the acidified amino acid solution may be for a period of about 30 minutes to about 150 minutes, about 30 minutes to about 120 minutes, about 30 minutes to about 90 minutes, about 30 minutes to about 60 minutes, about 60 minutes to about 150 minutes, about 90 minutes to about 150 minutes, about 120 minutes to about 150 minutes, or about 80 minutes to about 100 minutes.

During incubating, the one or more plant parts may be incubated with the acidified amino acid solution with the assistance of a kinetic device. The kinetic device is not particularly limited and exemplary kinetic devices may be stirrers, ultrasonicators, agitators, subcritical flow, pressure pumps, reflux, soxhlet extraction apparatus or combinations thereof.

The method may further comprise repeating the incubating of the one or more plant parts with the acidified amino acid solution at least one time.

The method may further comprise removing the acidified amino acid solution from the one or more plant parts after incubating, or where the incubating is repeated, after each round of incubating and before the next round of incubating. The removing may be undertaken by washing with water, organic solvent, spray drying, freeze drying, draining, filtration, centrifugation, lyophilization, or evaporation.

The method may further comprise purifying the one or more plant parts after the incubating or where the incubating is repeated, after the final incubating. The purifying may be undertaken by is not particularly limited and exemplary methods may include washing, neutralizing with pH, decanting, centrifugation, lyophilizing or filtering.

The method may further comprise (i) separating a supernatant of a reaction mixture as a result of incubating the mixture of the one or more plant parts with the acidified amino acid solution, and (ii) subjecting the supernatant of (i) to anion-exchange chromatography or size exclusion chromatography or ultrafiltration.

During separating (i), the supernatant may be separated from the reaction mixture with the assistance of a device. The device may be a centrifuge, an ultracentrifuge, tangential flow filtration or a membrane filter.

During separating (ii), the anion-exchange chromatography may be performed in a stepwise isolation process to separate distinct proteins based on the supernatant pH that they are separated in during the anion-exchange chromatography process. The supernatant pH may be adjusted after the completion of each isolation process at the previous pH and before the commencement of the next isolation process at the next pH. The pH may be sequentially adjusted lower after the completion of each isolation process.

During separating (ii), the supernatant pH may be sequentially adjusted to be about 7.0, about 6.0, about 5.0, about 4.0, about 3.0, about 2.0, or about 1.0. The supernatant pH may be adjusted with an acid, an alkali, a base, or combinations thereof.

After separating (ii), any amino acids that are isolated during separating step (ii) may be recycled for a subsequent detoxification.

The disclosed method therefore involves detoxification, nutrient enrichment and recyclability. Addition of the acidified amino acid solution may lead to rapid detoxification of both free and bound gossypol while the excess amino acid trapped in the degossypolised plant parts increases the amino acid content. After extraction, the amino acid is collected and could readily be recirculated for the next purification. The high recyclability of the amino acid involved in the method aims to maximize economic output and reduce waste production. In addition, the amino acid-supplemented degossypolised plant parts may increase the total protein content and food quality, and also aid in enhancing fertility and health in both animal and human over long-term consumption.

Exemplary, non-limiting embodiments of a protein isolate will now be disclosed.

The protein isolate may have a total gossypol content of less than 250 ppm.

The protein isolate may have a total gossypol content of less than 250 ppm, less than 200 ppm, less than 180 ppm, less than 160 ppm, less than 140 ppm, less than 130 ppm or less than 120 ppm.

The protein isolate may have resulted from the one or more plant parts having undergone the gossypol removal of the method as defined herein.

The protein isolate may have a remaining free gossypol content of less than 5%, less than 4%, less than 3%, less than 2.5%, less than 2%, less than 1.5% or less than 1% as compared to the free gossypol content in the one or more plant parts prior to gossypol removal, where the gossypol removal is of the method as defined herein.

The protein isolate may have a remaining bound gossypol content of less than 5%, less than 4%, less than 3%, less than 2.5%, less than 2%, less than 1.5% or less than 1% as compared to the bound gossypol content in the one or more plant parts prior to gossypol removal, where the gossypol removal is of the method as defined herein.

The protein isolate may have a remaining total gossypol content of less than 10%, less than 8%, less than 6%, less than 5%, less than 4%, less than 3%, less than 2%, or less than 1% as compared to the total gossypol content in the one or more plant parts prior to gossypol removal, where the gossypol removal is of the method as defined herein.

The protein isolate may have a protein content of about 90%, about 91%, about 92%, about 93%, about 94%, about 95%, about 96%, about 97%, about 98% or about 99% as compared to the initial protein content of the one or more plant parts prior to gossypol removal, where the gossypol removal is of the method as defined herein.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram depicting the release of protein bound gossypol via acid hydrolysis of gossypol Schiff's bases with amine group followed by iminization reaction with lysine to convert gossypol into the inactive form of lysine-conjugated gossypol.

FIG. 2 shows a schematic diagram for gossypol isolation followed by stepwise removal of different proteins, gossypol and lysine via anion exchange chromatography.

FIG. 3 is a workflow depicting the process of gossypol removal with three different acidified lysine treatments and the remaining total gossypol content.

FIG. 4 is a graph depicting the amount of released protein bound gossypol and the remaining total gossypol content after gossypol detoxification using acidified lysine and ethanol.

### EXAMPLES

Non-limiting examples of the invention and a comparative example will be further described in greater detail by reference to specific Examples, which should not be construed as in any way limiting the scope of the invention.

### Example 1: Release of Protein Bound Gossypol via Acid Hydrolysis and Iminization Reaction with Lysine in Acidified Amino Acid Solution

Cottenseed was used to produce cottonseed protein and cottonseed meal by the removal of free and bound gossypol using the method disclosed of incubating a mixture of the one or more plant parts (being cottonseed protein) with an acidified amino acid solution.

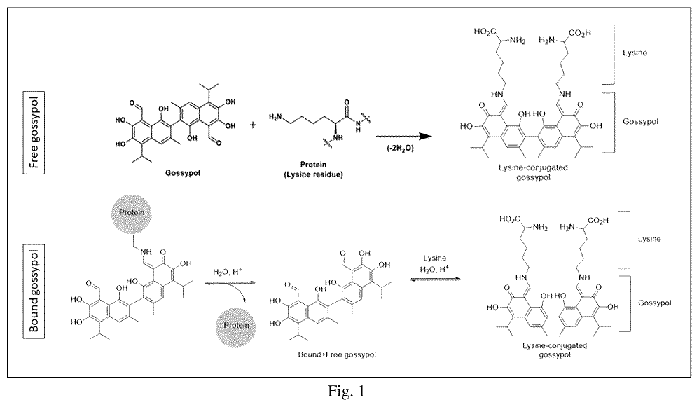

FIG. 1 shows a method of removing gossypol where the amino acid used was lysine. Here, the free gossypol was removed by the promotion of the iminization of the free gossypol with excess lysine under an acidic environment. Protein bound gossypol was released via acid hydrolysis to disassociate protein bound gossypol from the cottonseed protein, and the protein was removed from the disassociated bound gossypol by solvation of the protein in alcohol, followed by iminization reaction with lysine to convert gossypol into the inactive form of lysine-conjugated gossypol. Acid hydrolysis of bound gossypol by the iminization of free gossypol was promoted with an acidic environment with wet alcohol containing excess amounts of lysine (about ten times mol % of gossypol).

The steps of an embodiment of a gossypol detoxification process according to the method disclosed herein are as follows:
1. De-oiled cottonseed meal was first turned into milled powder by milling.
2. Free gossypol was extracted from the milled cottonseed meal by incubating the milled cottonseed meal with 3 volumes of acid ethanol (0.34 M phosphoric acid in 95% ethanol) for 1 hour under constant and vigorous stirring in ambient temperatures.
3. The acid ethanol was removed.
4. Steps 2 and 3 were then repeated once.
5. The cottonseed meal was added to an acidified amino acid solution (10 mM lysine in 0.34 M phosphoric acid water [with or without 95% ethanol]) in a 1:1 volume ratio) and heated to 50° C. for one to two hours with vigorous stirring to release any protein bound gossypol by acid hydrolysis and iminization of free gossypol with excess free lysine.
6. The aqueous lysine phosphoric acid solution was removed by vacuum filtration or centrifugation.
7. The excess released bound gossypol was extracted from the cotton seed protein by adding acidified amino acid solution comprising 10 mM lysine and 0.34 M phosphoric acid in 95% ethanol in a 1:3 volume ratio (protein:solution).
8. The ethanol was removed from the insoluble degossypolized cottonseed proteins with ultra-low total gossypol content, which is subsequently evaporated and dried to remove any residual liquid.
9. The protein was washed with alkaline water to neutralize the pH before lyophilization or spray drying to obtain the final dry high quality cottonseed protein isolate with ultra-low total gossypol content.

### Example 2: Stepwise Removal of Different Proteins, Gossypol and Lysine via Anion Exchange Chromatography

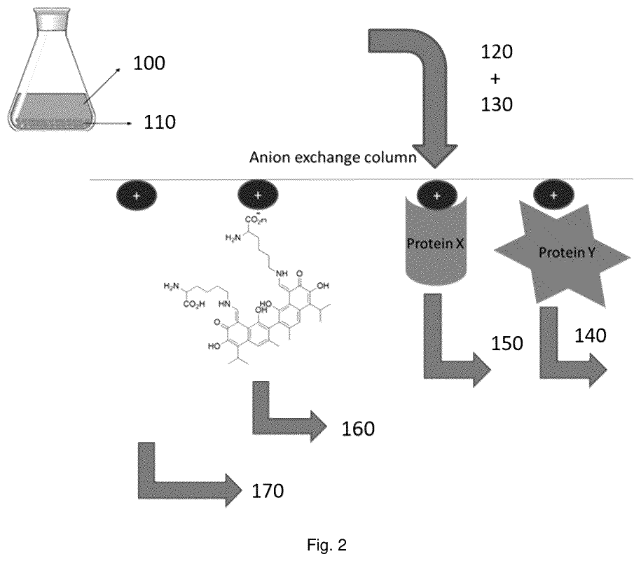

A stepwise removal of different proteins, gossypol and lysine via anion exchange chromatography is shown in FIG. 2. The supernatant 100 that was separated after the acidic incubation should contain a mixture of the following: released gossypol, soluble proteins, complex carbohydrates and impurities as well as lysine. By adjusting the pH of the supernatant to 7.0 in 120, all the carboxylic groups present on lysine and C-terminal of the soluble proteins were converted to the corresponding carboxylate ions. In order to ensure successful separation of the proteins and removal of the gossypol from the mixture, yet ensuring economic viability, anion-exchange chromatography was employed for the separation by transferring the supernatant 100 into an anion exchange column 130. Anion exchange chromatography is a powerful technique which offer excellent control in binding analytes based on charge availability on the analyte surface. Subtle changes in pH modify the charges on the analytes, ensuring efficient dissociation from the resin surface.

Equilibration of the supernatant pH in an anion exchange column can result in binding of negatively charged analyte to the column surface. This kicked off a stepwise isolation process of different proteins based on their pH. This is visualized in FIG. 2 during step 140, where proteins that did not bind at pH 7.0 were first isolated from the flowthrough together with other impurities which could potentially be complex carbohydrate or non-charge species. Gradual adjustment of the pH subsequently eluted various proteins in step 150 until the pH of 3.0. To remove the gossypol from the column in step 160, the acidic pH of 3.0 was coupled with an increase in temperature to readily promote the dissociation of gossypol from lysine. Collection of the flowthrough followed by a recrystallization process yielded gossypol. Finally, a decrease in the pH to 2.0 in step 170 protonated the carboxylic acid on the lysine, resulting in rapid dissociation and isolation of lysine.

The main advantage in using anion-exchange chromatography is the stepwise removal of all nutritionally important proteins, which upon isolation could be reintroduced back into the degossypolized insoluble cottonseed meal 110, improving its net protein quality. At the same time, lysine was collected and could readily be circulated into the next purification while gossypol was isolated from the workflow. Excess lysine that was trapped in the degossypolized cottonseed meal also served to increase the amino acid content as cottonseed meal usually have reduced lysine level compared to other conventional protein meals. This stepwise removal and separation of different proteins, gossypol and lysine resulted in the high recyclability of the materials involved in the workflow and facilitated maximizing economic output and reduced waste production in the manufacture of ultra-low gossypol content cottonseed protein isolates.

### Comparative Example: Comparative Example Between Acidified Amino Acid Solution and Acidified Ethanol Solution

The gossypol detoxification method of the present disclosure (P1) was compared with a control comparative example (C1) with a detoxification method with an acidified solution that did not include an amino acid.

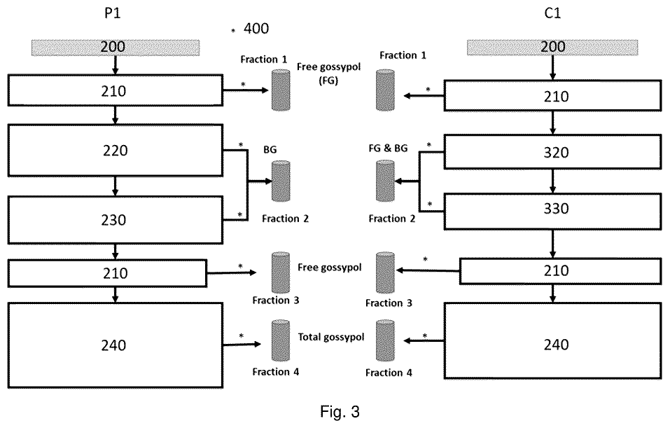

The method procedures for P1 and C1 are shown in FIG. 3, where the same dried protein pellets 200 were first treated in step 210 with 95 vol % ethanol in a 1:10 volume ratio and agitated vigorously at room temperature for 60 minutes to incubate and extract free gossypol from the protein pellets. The mixture was then treated with process 400 where the mixture was centrifuged at 14,000 g for 15 minutes at 4° C. to separate the supernatant and protein pellet, while the supernatant was collected for subsequent analysis of free and bound gossypol removed from the protein pellet.

Thereafter, P1 was treated with solution 220 and incubated in a 1:5 volume ratio of an acidified amino acid solution comprising of 50 mM lysine, 0.34 M phosphoric acid and 95 vol % ethanol, while C1 was treated with solution 320 and incubated in a 1:5 volume ratio of an acidified ethanol solution comprising of 0.34 M phosphoric acid and 95 vol % ethanol. Both samples P1 and C1 were incubated for 90 minutes under vigorous agitation at 50° C. in a first incubation with said acidified solutions.

P1 and C1 were subsequently incubated again with refreshed acidified amino acid solutions and acidified ethanol solutions 220 and 320 but in a 1:3 protein to solution volume ratio for P1 230 and C1 330 respectively, for 30 minutes under vigorous agitation at 50° C. in a second incubation with said acidified solutions. The mixture was treated with process 400 where the mixture was centrifuged at 14,000 g for 15 minutes at 4° C. after each incubation with acidified solutions to separate the supernatant and protein pellet, while the supernatant was collected for subsequent analysis of free and bound gossypol removed from the protein meal.

The samples were again treated using step 210 with 95 vol % ethanol in a 1:10 volume ratio and agitated vigorously at room temperature for 15 minutes under agitation to remove any remnants of free gossypol. The mixture was again treated with process 400 where the mixture was centrifuged at 14,000 g for 15 minutes at 4° C. to separate the supernatant and protein pellet, while the supernatant was collected for subsequent analysis of free and bound gossypol removed from the protein pellet.

Finally, the protein pellet was treated with process 240 where it was complexed at a 1:8 volume ratio with a complexing agent (2% of 3-amino propanol:10% of glacial acetic acid:88% N,N-dimethylformamide) and agitated vigorously for 30 minutes at 90° C. and cooled down to room temperature. The mixture was then diluted in a 1:4 volume ratio to 0.1% phosphoric acid in 80% ethanol solution. The complexing and dilution procedure was repeated once, and the mixture was treated with process 400 where the mixture was centrifuged at 14,000 g for 15 minutes at 4° C. to separate the complexed gossypol supernatant and protein pellet, with the complexed gossypol supernatant used to subsequently determine the final total gossypol content left in the final protein isolate after the gossypol detoxification methods of P1 and C1.

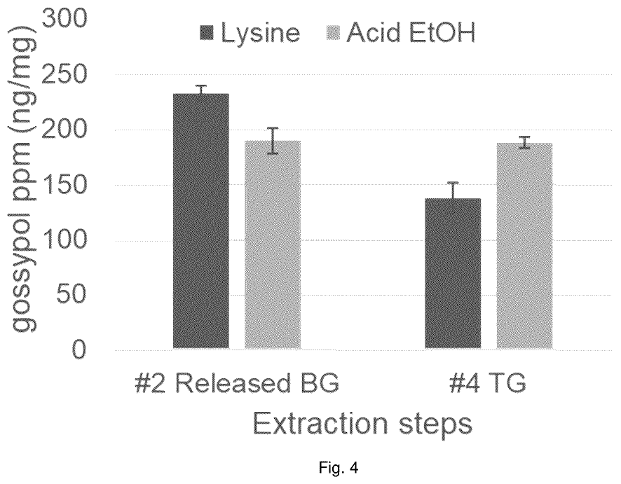

As seen from FIG. 4, the gossypol detoxification method of P1 using an acidified amino acid solution comprising of 50 mM lysine, 0.34 M phosphoric acid and 95 vol % ethanol released a higher amount of bound gossypol (232.5 ppm) as compared to the gossypol detoxification method of C1 using an acidified ethanol solution comprising of 0.34 M phosphoric acid and 95 vol % ethanol (189.2 ppm). The higher concentration of bound gossypol removed by the detoxification method of P1 is an advantage over the detoxification method of control sample C1 as bound gossypol may be broken down into free gossypol during digestion in the digestive tract of non-ruminants and is undesirable.

The total gossypol content left in the final protein isolates is shown in Table 1. The total gossypol content for P1 was lower at 137 ppm as compared to 188 ppm for control sample C1. This represented a 27% reduction of total gossypol content in protein isolate P1 as compared to C1, evident of the advantage of an acidified amino acid solution gossypol detoxification method over a comparative acidified ethanol gossypol detoxification control method in reducing the concentration of total gossypol content left in a protein isolate after gossypol detoxification.

TABLE 1

| | Degossypol | Initial | Remaining | Remaining | |
|---|---|---|---|---|---|
| Sample | method | TG (ppm) | TG (ppm) | TG (%) | Remarks |
| P1 | 50 mM Lysine, | 5245.8 | 137.3 | 2.61 | Present |
| | 50° C., 90 | | | | disclosure |
| | minutes | | | | |
| C1 | Acid EtOH, | 5245.8 | 187.9 | 3.58 | Control |
| | 50° C., 90 | | | | sample |
| | minutes | | | | |
| C2 | Acid EtOH, | 11700 | 640 | 5.47 | Prior art |
| | 82-83° C., 2 | | | | |
| | hours | | | | |

In another example C2, a previous study used an acidified ethanol solution comprising 95% ethanol and 1.4 M phosphoric acid to incubate the protein extract for 2 hours at 82° C. to 83° C. The initial gossypol content of 11700 ppm was reduced to 640 ppm of total gossypol content after the gossypol detoxification, which translated to a remaining total gossypol content of 5.47% from the initial total gossypol content. This is yet again significantly higher than the 2.61% remaining total gossypol content of sample P1, yet again evident of the disadvantage of an acidified ethanol gossypol detoxification as compared to the acidified amino acid solution gossypol detoxification method of the present disclosure.

### INDUSTRIAL APPLICABILITY

The method of removing gossypol from one or more plant parts may produce an alternative protein feed and high-quality protein isolate. The method of removing gossypol reduces the total gossypol content in the plant parts to a greater extent as compared to methods in the prior art and allows for amino acid recycling and reintroduction into the protein isolate for nutrient enrichment. The resulting protein feed and high-quality protein isolate is non-toxic and safe for human consumption and animal consumption and has a gossypol concentration under the 600 ppm maximum allowable limits per United Nations Food and Agriculture Organization and World Health Organization guidelines for food applications with gossypol content, and may be used for the animal feed industry and the human food industry as an alternative plant protein source.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of removing gossypol from one or more plant parts, comprising incubating a mixture of the one or more plant parts with an acidified amino acid solution, wherein amino acid comprises more than one nitrogen-containing functionality.

2. The method of claim 1, wherein the acidified amino acid solution comprises an acid, an amino acid, and a solvent.

3. The method of claim 2, wherein the acid is phosphoric acid, acetic acid, oxalic acid, methanoic acid, ethanoic acid, benzoic acid, citric acid, sulfuric acid, hydrochloric acid, or mixtures thereof.

4. The method of claim 1, wherein the acidified amino acid solution has an acid concentration of 0.1 M to 1 M.

5. The method of claim 1, wherein the amino acid is selected from the group consisting of lysine, arginine, methionine, serine, histidine, and mixtures thereof.

6. The method of claim 1, wherein nitrogen-containing functionality is an amine or a guanidine.

7. The method of claim 1, wherein the acidified amino acid solution has an amino acid concentration of 10 mM to 100 mM.

8. The method of claim 2, wherein the solvent is an organic solvent, ethanolamine, ammonia, water, or mixtures thereof.

9. The method of claim 8, wherein the organic solvent is ethanol, methanol, isopropanol, butanol, acetone, or acetonitrile.

10. The method of claim 2, wherein the solvent is a mixture of organic solvent and water in a ratio of 10:90, 30:70, 50:50, 70:30, 75:25, 80:20, 85:25, 90:10, 95:5, or 99:1.

11. The method of claim 1, wherein the plant parts are seeds, roots, stems, leaves, husks, hulls, flower buds, or mixtures thereof.

12. The method of claim 1, wherein the plant parts come from a plant, where the plant is one that produces gossypol.

13. The method of claim 12, wherein the plant is cotton, okra, soybean, or sunflower.

14. The method of claim 1, wherein the incubating is undertaken at a temperature of 30° C. to 90° C.

15. The method of claim 1, wherein the incubating is undertaken for a time period of 30 minutes to 150 minutes.

16. The method of claim 1, wherein the method further comprises the following steps:
(i) separating a supernatant of a reaction mixture as a result of incubating the mixture of the one or more plant parts with the acidified amino acid solution, and
(ii) subjecting the supernatant of (i) to anion-exchange chromatography, size exclusion chromatography, or ultrafiltration.

17. A protein isolate having a total gossypol content of less than 250 ppm.

18. The protein isolate of claim 17, wherein the protein isolate is a result from one or more plant parts having undergone a gossypol removal method comprising incubating a mixture of the one or more plant parts with an acidified amino acid solution, wherein amino acid comprises more than one nitrogen-containing functionality.

19. The protein isolate of claim 18, wherein the protein isolate has a remaining gossypol content of less than 5% as compared to a gossypol content of the one or more plant parts prior to gossypol removal.

20. The protein isolate of claim 18, wherein the protein isolate has a protein content of more than 90% as compared to an initial protein content of the one or more plant parts prior to gossypol removal.
